(19) United States
(12) Patent Application Publication
(10) Pub. No.: US 2010/0076850 A1
(43) Pub. Date: Mar. 25, 2010

(54) Targeting Ads by Effectively Combining Behavioral Targeting and Social Networking

(76) Inventors: Rajesh Parekh, San Jose, CA (US); Abraham Bagherjeiran, Sunnyvale, CA (US)

Correspondence Address: Stattler-Suh PC, 60 SOUTH MARKET, SUITE 480, SAN JOSE, CA, 95113, US

(21) Appl. No.: 12/235,414

(22) Filed: Sep. 22, 2008

(51) Int. Cl. G06Q 30/00

(52) U.S. Cl. 705/14.66; 705/1

(57) ABSTRACT

A method and system are provided for targeting ads by effectively combining behavioral targeting and social networking. In one example, the method includes receiving a behavioral targeting model to predict a propensity of each consumer in a network to select (e.g., click) an ad of a particular category based on a behavior of each consumer, training a social network model to predict a propensity of a particular consumer to select an ad of the particular category based on features derived from a social network of the particular consumer, and training an ensemble classifier to decide when to trust the behavioral targeting model and when to defer to the social model for predicting a propensity of the particular consumer to select an ad of the particular category.

### FIELD OF THE INVENTION

The present invention relates to online advertising. More particularly, the present invention relates to targeting ads by effectively combining behavioral targeting and social networking.

### BACKGROUND OF THE INVENTION

Online networks, such as the Internet, connect a multitude of different users to an abundance of content. Just as the users are varied, the content is similarly varied in nature and type. In particular, the Internet provides a mechanism for merchants to offer a vast amount of products and services to consumers.

Leveraging social network information for ad targeting is becoming increasingly popular. Social Networks provide information about users that is not explicit in the behavior of individual users.

A key challenge with the behavioral targeting system is that it does not perform very well for users with little or no behavioral history, as in the case of new users or lightly engaged users. Social information can be highly useful in these cases where an ad system does not know much about the users but instead knows a lot about their social connections. Information about the users' social connections may be leveraged effectively to make predictions about the users' own interests. One important problem is how the ad system should effectively combine users' behavioral information with social information.

There are two main requirements for effective advertising in social networks. The first is that links in the social network are relevant to the targeted ads. The second is that social information can be easily incorporated with existing targeting methods to predict response rates.

Effective advertising requires predicting how a consumer will respond to an advertisement. Typically this means constructing a profile of users based largely on passive observation, through their interaction with the network. Any predictions made from this profile are only the ad system's best guess as to what the consumer will do. Social networking sites allow users to declare explicitly their interest in products and to declare their relationships with other users through social connections. Although users will explicitly tell the ad system their interests, it is still unclear how to relate these interests to predict response rates.

A key feature, required of social networks to be useful for advertising, is that people tend to share interests with their friends and tend to be friends with people who share their interests. This feature, known as homophily, has been shown in many social networks. To understand the presence and benefit of homophily, several questions are answered relevant to advertising on social networks: Do friends tend to see similar ads? Does having friends who responded to ads in the past influence a person to respond in the future? Do users who are similar tend to be friends?

Although social networks provide valuable insight into a consumer's interests, a consumer's future behavior is also largely dependent on the consumer's past behavior.

### SUMMARY OF THE INVENTION

What is needed is an improved method having features for addressing the problems mentioned above and new features not yet discussed. Broadly speaking, the present invention fills these needs by providing a method and system for targeting ads by effectively combining behavioral targeting and social networking. It should be appreciated that the present invention can be implemented in numerous ways, including as a method, a process, an apparatus, a system or a device. Inventive embodiments of the present invention are summarized below.

In one embodiment, a method is provided for targeting ads by effectively combining behavioral targeting and social networking. The method comprises receiving a behavioral targeting model to predict a propensity of each consumer in a network to select (e.g., click) an ad of a particular category based on a behavior of each consumer, training a social network model to predict a propensity of a particular consumer to select an ad of the particular category based on features derived from a social network of the particular consumer, and training an ensemble classifier to decide when to trust the behavioral targeting model and when to defer to the social model for predicting a propensity of the particular consumer to select an ad of the particular category.

In another embodiment, a system is provided targeting ads by effectively combining behavioral targeting and social networking. The system is configured for receiving a behavioral targeting model to predict a propensity of each consumer in a network to select an ad of a particular category based on a behavior of each consumer, training a social network model to predict a propensity of a particular consumer to select an ad of the particular category based on features derived from a social network of the particular consumer, and training an ensemble classifier to decide when to trust the behavioral targeting model and when to defer to the social model for predicting a propensity of the particular consumer to select an ad of the particular category.

In still another embodiment, a computer readable medium carrying one or more instructions for targeting ads by effectively combining behavioral targeting and social networking is provided. The one or more instructions, when executed by one or more processors, cause the one or more processors to perform the steps of receiving a behavioral targeting model to predict a propensity of each consumer in a network to select an ad of a particular category based on a behavior of each consumer, training a social network model to predict a propensity of a particular consumer to select an ad of the particular category based on features derived from a social network of the particular consumer, and training an ensemble classifier to decide when to trust the behavioral targeting model and when to defer to the social model for predicting a propensity of the particular consumer to select an ad of the particular category.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a block diagram of a system for targeting ads by effectively combining behavioral targeting and social networking, in accordance with an embodiment of the present invention;

FIG. 2 is a graphical representation of many overlapping ad-relevant social networks, in accordance with an embodiment of the present invention;

FIG. 3 is a block diagram that illustrates relationships between five (5) logistic regression classifiers (i.e., models) for configuration in the targeting system, in accordance with an embodiment of the present invention; and

FIG. 4 is a flowchart of a method for targeting ads by effectively combining behavioral targeting and social networking, in accordance with an embodiment of the present invention.

### DETAILED DESCRIPTION OF THE INVENTION

An invention for a method and system for targeting ads by effectively combining behavioral targeting and social networking is disclosed. Numerous specific details are set forth in order to provide a thorough understanding of the present invention. It will be understood, however, to one skilled in the art, that the present invention may be practiced with other specific details.

### General Overview

The method involves efficiently combining social network information with the existing single-consumer-based behavioral information to build a more effective targeting system. The method is designed to augment a behavioral targeting system of a company like Yahoo!® and to improve the system's ad targeting performance.

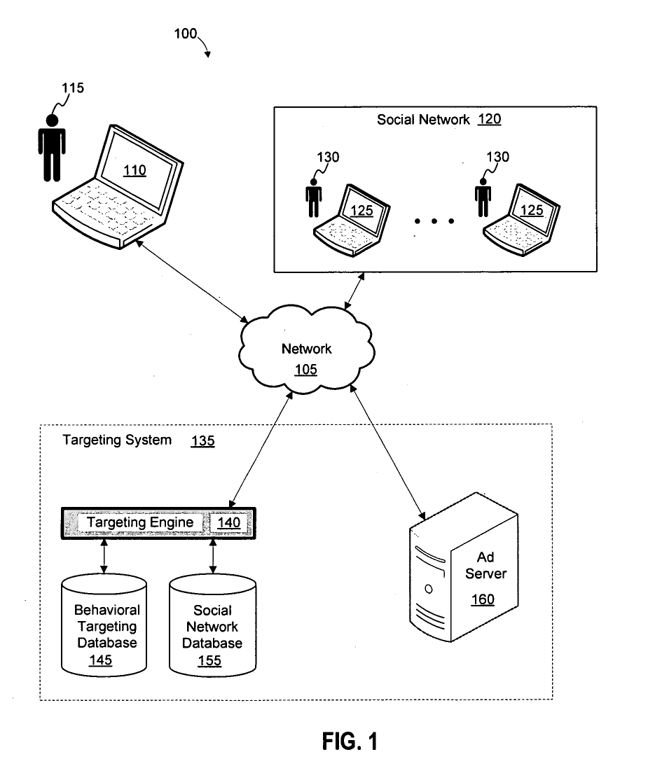

FIG. 1 is a block diagram of a system 100 for targeting ads by effectively combining behavioral targeting and social networking, in accordance with an embodiment of the present invention. The system 100 includes various devices that are coupled to each other. A device of the present invention is hardware, software or a combination thereof. A device may sometimes be referred to as an apparatus. Each device is configured to carry out one or more steps of the method of targeting ads the effectively combines behavioral targeting and social networking.

The network 105 couples together a consumer computer 110, a social network 120 a targeting engine 140 and an ad server 160. The network 105 may be any combination of networks, including without limitation the Internet, a local area network, a wide area network, a wireless network and a cellular network. A consumer 115 operates the consumer computer 110 which may be a laptop, a desktop, a workstation a cell phone, a smart phone, a mobile device, a satellite phone, or any other computing apparatus. The social network 120 includes without limitation friend computers 125 operated by friends 130 (i.e., users who share interests) of the consumer. The social network 120 may be coupled to a website, such as Yahoo!® IM (Instant Messenger), Yahoo!® Mail, Facebook.com, MySpace.com, the website being configured to gather analytics about click behavior of a friend 130. Note that in this embodiment the consumer 115 is depicted as not being part of the social network 120 for purposes of explaining processing steps of the targeting system 135.

The targeting engine 140 and the ad server 160 are part of the targeting system 135. The targeting engine 140 is coupled to a behavioral targeting database 145 and a social network database 155. The targeting engine 140 may reside in an application server (not shown). In another embodiment, the targeting engine 140 may reside in the ad server 160. In still another embodiment, the targeting engine 140 may reside across a combination of computing apparatuses, including without limitation an application server, an ad server or a web server.

The targeting system 135 is designed to solve specific problems. The targeting system 135 leverages an additional source of information, social information, resulting in better targeting models. The targeting system 135 focuses on users with insufficient behavioral information, for example, new or low engagement users and users on partner sites of a company like Yahoo!®. The targeting system 135 infers interests that do not manifest themselves in terms of “on-network” behavior. “On-network” means on the network of a company like Yahoo!®. For example, a consumer may be following all sports action on espn.com (“off network”) as opposed to sports.yahoo.com (“on network”). The targeting system 135 quantifies the value of social information, using information of friends 130 only, as well as information of friends in conjunction with behavior of consumer 115. The targeting system 135 develops and maintains effective models of combining behavior and social information. The targeting system 135 builds more robust and better performing models with regularization and social information. The targeting system 135 trains models that operate within constraints of current production systems.

The targeting engine 140 trains classifiers to predict whether a consumer 115 will select an ad in a particular category. One example of a “select” is a click on an ad using a computer mouse. Based on the behavior of the consumer 115, the targeting engine 140 receives (or trains) a behavioral targeting model. In other words, the targeting engine 140 receives (or trains) the consumer's behavioral targeting predicted score (or “score”), as well as each friend's behavioral targeting predicted score. A behavioral targeting predicted score represents the propensity of the consumer 115 to click on an ad.

Then, based on the behavior of the friends 130, the targeting engine 140 trains a social network model to predict the consumer's propensity to click on an ad given features derived from the social network 120. In other words, the targeting engine 140 predicts the propensity of the consumer 115 to click on an ad based only on the friends' behavioral targeting predicted scores.

The targeting engine 140 then trains an ensemble classifier to predict when to trust the consumer's score and when to defer to the social network model. In other words, the targeting engine 140 trains an ensemble classifier (i.e., friend trust model) to decide when a specific friend's score is a better predictor of a consumer's propensity to click on an ad than the consumer's own score. The resulting model effectively leverages social and behavior data to improve targeting performance.

There are two main requirements for effective advertising in social networks. The first is that links in the social network are relevant to the targeted ads. The second is that social information can be easily incorporated with existing targeting methods to predict response rates. The targeting system 135 addresses these requirements. The targeting system 135 measures the relevance of a social network to groups of ads. The targeting system 135 measures the degree to which social network information complements existing consumer-profile information for targeting. It has been found that there is significant evidence in a social network of homophily and that links in the social network indicate similar ad-relevant interests.

The targeting system 135 trains an ensemble classifier to combine existing consumer-only models with social network features to improve response predictions. The ensemble learning method combines these two sources of information when insufficient behavioral history is available. The results will show that the method improves on both a consumer only model and a model trained on social features.

The targeting system 135 may carry out online processing as well as offline processing. The offline processing may include building the behavioral targeting model and building the social network model. The combination of the models would include all of the scores, including the score of the consumer 115 and the scores of the friends 130. This offline processing may be carried out on a specialized application server (not shown). The specialized application server may later load the results of the processing onto the ad server 160.

The online processing may include the ad server 160 (or other server) monitoring events (e.g., clicking, browsing, texting, messaging, emailing, etc.) of the consumer 115 and of the friends 130. The ad server 160 may incrementally update the scores based on the monitored events. The ad server 160 may also send the monitored events to the targeting engine 140. The targeting engine 140 may use the monitored events for further fine tuning of the models.

### Data Sources

The data comes from two main sources, including activity generated by a consumer 115 and information collected from the social network 120. Once a consumer 115 has logged into a network 105 (e.g. Yahoo!®), that consumer 115 builds an historical profile, which may include without limitation pages visited, searches, ad views and ad clicks. The targeting system 135 collects this “on network” consumer behavior information over a time period to form a behavioral profile of the consumer 115. This collection process involves collecting the behavioral information of each of the users 130 of the social network 120. Further, the targeting system 135 may collect social network information containing users and their social relationships with other users using, for example, Yahoo!® IM, Yahoo!® Mail, Facebook.com, MySpace.com, among other applications. The targeting system 135 represents this social network information as a social graph (not shown) that quantifies where a consumer is for predicting ad clicking, as compared to where the consumer's friends are for predicting ad clicking. The social graph is used to compute features such as the number of friends, the connectivity strength between the consumer and the friends, the distribution of the friends' behavioral targeting predicted scores, among other features.

As an example, of the users who interact with the Yahoo!® network, 30% of them utilize Yahoo!® IM. As users exchange messages via Yahoo!® IM, their connections to their peers (Yahoo!® IM buddies) form a rich social network. The Yahoo!® IM allows users to exchange text, voice, and data between peers. The targeting system leverages information from the IM network such number of friends of a given consumer, number of messages exchanged between a users and his/her friends, demographics and geographic location of the consumer and his/her friends. To protect consumer privacy, the Yahoo!® IM system does not log the actual conversations that take place between users and their friends.

In order to show the most relevant ads to a consumer 115, the targeting system 135 needs to predict how many users are expected to see and, more importantly, click on a particular ad. The targeting system 135 trains a predictive consumer model (i.e., behavioral targeting model) to predict for each consumer a set of scores, indicating the probability that a consumer will click on a class of ad. Ads are categorized into C classes and predictive models are trained for each of these. After scoring the users, the targeting system 135 considers the users having the top scores as qualified for the ad class. This score threshold, called the operating point, is determined by the actual number of views during the training period. If the advertiser wants to sell 1,000 impressions, users are selected until the targeting system 135 reaches 1,000 impressions. If the total number of impressions is 10,000, the operating point is 10% of the impressions. A goal for training the models is to maximize the cumulative response rate, called CTR (click-through rate), of the users at the operating point.

### Ad Clicking as a Social Activity

Consider a given consumer u and the set of the consumer's friends (i.e., users who are explicitly linked to the give consumer on the social network), N(u) Suppose some concept c is true for k of u's friends. Intuition suggests that the concept c is likely to be true for u, and is more likely as k grows, that is P(c|u, N(u))×k. The main reason for this conclusion is that it is expected that u's friends are indicative of u's interests. There is also more confidence in the prediction than if all of u's friends were unknown. This tendency of friends to have similar interests is called “homophily”. Conversely, if people are friends, then it is expected that they have similar interests. The presence of homophily has many implications for ad targeting. It suggests that the simple strategy of targeting a consumer's friends with ads will have a similar effect as targeting the consumer with ads.

As an example, if homophily were to be present in the Yahoo!® IM graph, it would imply that friends tend to see similar ads. This is because ads are typically targeted based on the characteristics of users such as age, gender, and where they are on the network. Because friends tend to be similar, the targeting system 135 tends to target friends with similar ads.

Knowing the set of friends for a consumer provides many opportunities for advertising. For example, the targeting system 135 may target so-called influential users who will spread the message to their friends. This knowledge is particularly useful if a consumer is linked to friends with whom they have similar interests. If this knowledge were to exist with respect to the historical data, it would be expected that, collectively, users and their neighborhoods have above-average CTR. If the targeting system 135 targeted a consumer and some of the consumer's friends, rather than just the consumer specifically, two important results are expected. First, the CTR should be close to what would be achieved targeting only the consumer. Second, the reach should be much higher because the targeting system 135 is targeting many more users; the reach should increase by at most the average number of friends.

Friends influence ad clicks. Suppose a consumer u purchases a product q and is extremely satisfied with this product. One would expect u to tell the consumer's friends about q. Some of the friends might be persuaded to buy it in the future. A common belief in social science research is that the total number of purchases of q that can be attributed to u increases with the number of friends that u has. These users are called influencers. In the current context of targeting ads to users in an online system, we are interested in understanding if a friend's propensity of clicking on an ad has any implications on the consumer's own propensity of clicking on the same ad in the future. Our analysis of ad behavior on the Yahoo! IM network has shown that having friends who clicked on an ad in the past increases the probability that a consumer will click in the future.

A consumer may input the consumer's friends in a number of different ways. In one example, the consumer 115 declares the consumer's friends list in an interface of a messenger device. The targeting system 135 then logs the consumer's friends list. In other words, as soon as the particular consumer 115 agrees to be friends with another messenger consumer 130, that messenger consumer 130 appears on friends list of the particular consumer 115. The targeting system 135 has this data available to the targeting system 135 directly. Further, the logs of the messenger device store information about the frequency of communications between two users. This data is also leveraged by the targeting system 135 to determine the strength of the relationship. Note that, for privacy reasons, the targeting system 135 preferably does not store the actual messages exchanged between any two users.

Consider the neighborhood of a consumer and the consumer's friends. Friends are expected to have similar interests, seeing similar ads and clicking on them. However, in a large social network like Yahoo!®, there are likely to be many users who see similar ads. Some of these users will be friends but others will be completely unaware of each other. A high level of intersection between friends and pairs of similar users implies that a consumer's social network captures all relevant information for that consumer. A low level of intersection implies that behavior is still relevant for targeting. It has been found that many of a consumer's friends are among the top 25 most similar users; the behavior of pairs of friends is often as similar as the most possible similar users.

### Combining Behavioral and Social Models

The social network 120 of a consumer can influence the consumer 115 toward adopting some product or service or clicking an ad. A behavior of an individual consumer 115 may be more relevant than the social network 120 in predicting whether an ad is clicked. On the other hand, sometimes the social network 120 is more relevant. The contribution of the social network relative to the behavior is always in flux, depending on behavior. However, social networks can enhance a consumer's behavior to predict whether the consumer will click on an ad in the future. Given the behavioral data and social data available for all users, the targeting system 135 combines this data to assign each consumer a new score \hat{p}^{1(u)} which approximates the probability that the consumer will click an ad The behavioral targeting model outputs two scores for each consumer, c and v, representing the predicted number of clicks and views of the consumer. The score p is the (smoothed) ratio of the component scores. The view score, v, is taken as a confidence measure in that users who are expected to view more ads give us more behavioral data for which to train the model.

Weighted Combination of Scores

Consider a consumer and online social neighborhood of the consumer 115. When the consumer first appears on the network 105, historical profile of the consumer 115 contains little predictive data. However, the social connections that link the consumer 115 to other users 130 who may have longer histories. In cases such as this, when there is insufficient data for the behavioral targeting predictive sore of the consumer 115 to be trusted, the social network 120 serves as a proxy for the historical profile. The targeting system 135 starts with a simple smoothing method, a convex combination of the consumer's score and a global prior. In one example, this smoothing method is defined according to

\hat{p}^{1(u)}=α\hat{p}^{(u)}+(1−α) p̅ Equation 1:

where p̅ is a default score (the global prior) and 0≦α≦1 is a constant that controls the level of smoothing. Equation 1 applies smoothing equally to all users and to a global constant, which is far too broad for the application here. To control the degree of smoothing at a consumer level, the smoothing constant depends on the view score, which is a proxy for the confidence in the estimates of the consumer's score:

$$α ( {\hat{v}}^{( u )} ) = \frac{{\hat{v}}^{( u )}}{{\hat{v}}^{( u )} + γ} \qquad Equation 2$$

where \hat{v}ᵢ^{(u)} is the consumer's view score and γ is a constant capturing the default confidence in the view score, which was empirically determined to be γ=1. Next, the global default score p̅ is dependent on the consumer's neighborhood. If there is low confidence in the consumer's score and high confidence in the score of the consumer's friends, the targeting system 135 is configured to assume that the friends inform the targeting system 135 about the consumer's actions. However, if there is little or no confidence in the score of the consumer or the score of the consumer's friends, the targeting system 140 still relies on the global default score. In one example, the definition for the consumer's default score is

$$\begin{matrix}{\hat{v}}^{( N )} = {\sum }_{f ∈ N} {\hat{v}}^{( f )} , and & Equation 3 \\ {\overline{p}}^{( u )} = β ( {\hat{v}}^{( N )} ) {\hat{p}}^{( N )} + ( 1 - β ( {\hat{v}}^{( N )} ) ) \tilde{p} & Equation 4\end{matrix}$$

where β(•) is defined similarly to α(•) and controls the smoothing of the friends' scores against the global default score \tilde{p}, which is the average CTR of the category being modeled. The aggregate scores of the friends is their weighted average (e.g., computed from a Yahoo!® IM graph). In one example, this weighted average is defined according to

$${\hat{p}}^{( N )} = \frac{{\sum }_{f ∈ N} {w}_{u , f} {\hat{c}}^{( f )}}{{\sum }_{f ∈ N} {w}_{u , f} {\hat{v}}^{( f )}} \qquad Equation 5$$

where ĉ and \hat{v} are the click and view scores of the friends, w_{u,f} is the number of conversations between users u and f, and N is the neighborhood of the consumer, an abbreviation of N(u). Note that the targeting system 135 averages the click and view scores separately and then divides rather than averages the ratios.

Training Social Models

Social models provide a different perspective on the tendency for users to click on ads. Training social network models on the entire history of users and their friends quickly becomes a challenge. Instead, the social network model is configured to use a social graph and takes into account at least one of the following set of features:
Neighborhood comprises the immediate 1-level friends, the set N=N(u)
This neighborhood is further restricted to the set N′ which represents the set of friends of consumer u whose expected view score is in the top 90% of all view scores.
Predicted scores \hat{p}i for all ad classes 1≦i≦k (i.e., distribution of predictive scores)
Similarity (i.e., connectivity strength) between ads seen by users and their friends
Gender and age of all users
Total clicks and views on an ad in category i during the training period

The targeting system 135 computes averages of several features with different weighting schemes, representing different notions of affinity for ad clicking among the users. The similarity of ad views w^{(θ)} to is the Jaccard similarity measure.

Provided here is a brief explanation of Jaccard similarity. Suppose the targeting system 135 computes the ad similarity between a pair of users as the number of ads both users have seen. Define αᵥ as the set of ads that the consumer u has seen. Define α_{f} as the set of ads some friend f ε N(u) has seen. The similarity of the ads seen by the pair users is defined as the Jaccard similarity of the sets αᵥ and α_{f}. This Jaccard similarity may be defined according to

$$θ ( {α}_{u} , {α}_{f} ) = \frac{\vert {α}_{u} ⋂ {α}_{f} \vert}{\vert {α}_{u} ⋃ {α}_{f} \vert} \qquad Equation 6$$

The targeting system 135 counts ads only once, so that if the consumer saw the same ad twice, it appears only once in the set. The targeting system 135 also ignores the time component. As a result, the similarity does not tell the targeting system 135 who saw the ad first, so it is difficult for the targeting system 135 to determine whether a consumer is influenced by the friend. Instead, the targeting system 135 is concerned with whether users have seen the similar ads as their friends.

The targeting system 135 gives more trust to friends that tend to see similar ads. The similarity between the click, view, and CTR scores are computed by creating a vector s^{(u)}=(s₁^{(u)}, . . . , sₖ^{(u)}) where each sᵢ^{(u)} is the score for ad class i and s ε {\hat{p}, ĉ, \hat{v}}. The weight w^{(s)} is then the cosine similarity of the scores between a consumer and the consumer's friend. The cosine similarity is defined for two real-valued users u and v as:

$${w}^{( s )} ( u , v ) = \frac{{s}^{( u )} \cdot {s}^{( v )}}{‖ {s}^{( u )} ‖ ‖ {s}^{( v )} ‖} .$$

For example, the weight w^{(\hat{p})} trusts friends more if the targeting system 135 expects those friends to click on ads similarly, but the weight w^{(\hat{v})} trusts friends if the targeting system 135 has similar confidence in those friends' view scores.

Learning to Trust Friends

The people with whom a consumer communicates during the course of a month may contain many people with different preferences such as family, co-workers, or acquaintances. When social connections have heterogeneous scores, aggregating over all friends can miss important relevant information. For example, if a consumer is looking to purchase a new car, that consumer may trust the recommendation of one friend over another. Accordingly, there is not just one social network. There are many overlapping social networks.

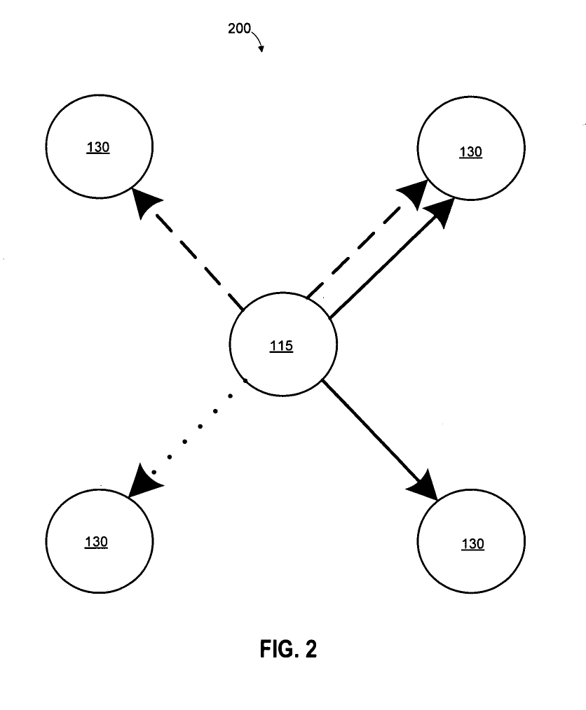

FIG. 2 is a graphical representation of many overlapping ad-relevant social networks 200, in accordance with an embodiment of the present invention. The consumer 115 trusts friends 130 differently in each class. Each class here is represented differently by different styles of directed edges. Each friend 130 is relevant to a specific ad class. For social network targeting, the first step is to find the set of relevant friends, in other words, who to trust for a specific ad category.

As a proxy for the trust relationship between two friends, the targeting system is configured to take an extremely pragmatic view of trust. The targeting system trusts a friend only when that friend's history is a better predictor of a consumer's behavior than the consumer's own history. For example, if consumer X has a friend A who is an avid ad-clicker in some category, the targeting system will trust A only when X also clicks in the category. If X does not click, that consumer is most influenced by the friend B who never clicked on an ad. In one example, this rule may be defined as

$$T ( u , f ) = \{ \begin{matrix}1 & {c}_{u} > 0 ⋀ {\hat{p}}^{( f )} > {\hat{p}}^{( u )} ⋁ {c}_{u} = 0 ⋀ {\hat{p}}^{( f )} \leq {\hat{p}}^{( u )} \\ 0 & otherwise\end{matrix} \qquad Equation 7$$

where a friend f is trusted if, had the targeting system replaced consumer u's score \hat{p}^{(u)} with the f's score \hat{p}^{(f)}, the targeting system would have correctly predicted whether u clicked on an ad in some ad class.

A logistic regression classifier is trained on this dataset. The classifier outputs a score Pr(T(u, f)|u, f) indicating the level of trust in each friend. A new set of social networks is created with weights equal to the trust scores for each ad class. Learning to trust friends well, however, does not necessarily translate to predicting clicks. For example, when a consumer does not click, that consumer will trust all friends with a lower score. The classifier does not tell the targeting system whether trusting the friends or not actually helps the targeting system predict any more clicks.

Ensemble Classifier

When a consumer's score is replaced with a new score, the targeting system must provide some level of confidence that the new score is actually better than the old score. Accordingly, the model for combining scores should never degrade performance with respect to the consumer-only model. The model should, at worst, be identical in performance to the original model. Ensemble classifiers are well-suited to these situations (i.e., combining the outputs of multiple classifiers). However, there are two main difficulties with casting this learning problem as an ensemble problem. First, transforming the consumer-only model into a classifier requires the operating point δ*, which is typically only available when the model is deployed in production. Second, a social network model trained to predict clicks learns the same target value from a different input distribution.

The consumer-only model predicts the probability that a consumer will click on an ad. In production, a consumer qualifies for an ad class by having a score higher than the operating point. In other words, \hat{p}^{(u)}≧δ*. Given this operating point δ*, the score \hat{p}^{(u)} is transformed into a binary class label (i.e., click or not-click). In this context, the model predicts that all the users with score above δ* will click and all users with score below δ* will not click. However, coupled with an operating point δ*, the targeting system may apply traditional ensemble methods from the machine learning literature to improve the scores.

The targeting system trains a social network model to predict clicks given features about the consumer and the consumer's friends. It has been found that the signal from the social features is weak at best. So, a simple linear combination of the classifier outputs from the behavioral targeting model and the social network model is likely to drown the signal. An example of a simple linear combination of the classifier outputs is weighted majority or ROC (Receiver Operating Characteristic) convex hull methods. Instead, the targeting system boosts the consumer-only model with the social network model whenever the consumer model has an error. This maximizes the contribution of the social network model and minimizes on the overall error.

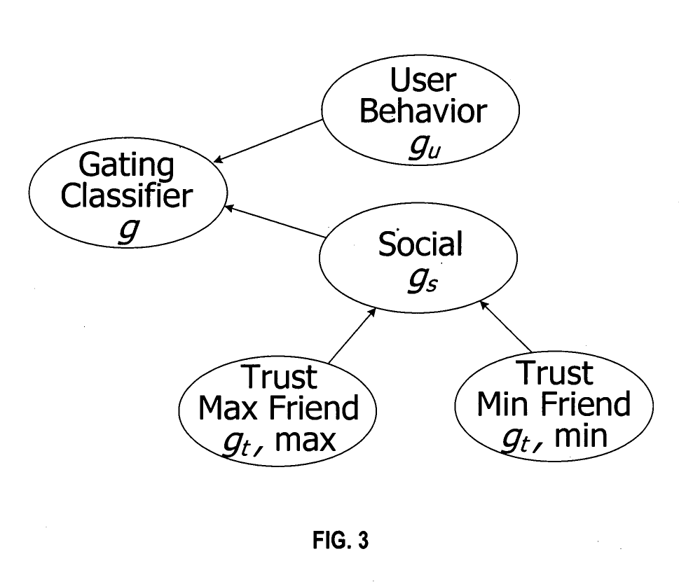

FIG. 3 is a block diagram that illustrates relationships between five (5) logistic regression classifiers (i.e., models) for configuration in the targeting system, in accordance with an embodiment of the present invention. The targeting system starts with the consumer-only classifier gᵤ that simply adjusts the range of the consumer's score \hat{p}^{(u)}. In one example, gᵤ may be defined according to

gᵤ(xᵤ)=σ(μ₁ log \hat{p}^{(u)}+μ₂) Equation 8:

where μᵢ are the parameters of the logistic model and is σ the logistic function. The targeting system trains the gating classifier g (i.e., the ensemble classifier) to select the best classifier between gᵤ and gₛ, as in the mixture of experts hierarchical learner. In one example, g may be defined according to

g(gᵤ; gₛ)=σ(μ₁ log gᵤ+μ₂ log gₛ+μ₃) Equation 9:

where gᵤ is the output of the consumer-only classifier and gₛ is the output of the social classifier. The targeting system trains the social network model gₛ classifier to predict click or not-click given features about the consumer and the consumer's neighborhood. The trust model, defined with respect to Equation 7, provides a score for each friend in the consumer's neighborhood. The targeting system selects the friends with the largest and smallest scores and the only friends a consumer could trust. These two friends provide the most relevant source of trust for the consumer. The targeting system should trust a friend with a very high score if the consumer is expected to click. The targeting system should trust a friend with a very low score if the consumer is expected not to click. The trust scores for each of these friends are additional features in the model, the output of the g_{t,min} and g_{t,max} models.

The ensemble classifier g combines the social network model gₛ with the consumer-only model gᵤ only when the consumer-only model gᵤ is expected to make an error, as in well-known machine learning approach of boosting. The targeting system trains the social network model gₛ to predict whether the consumer clicks on a re-weighted version of the examples. The targeting system computes the weights, as in a boosting algorithm, for correcting errors on a classifier. The targeting system implements one iteration of the boosting algorithm, using the consumer-only mode gᵤ as the first learner. In one example, the weights for each example in the ensemble classifier, m_i, are defined as

$${m}_{i} = \frac{1}{1 + exp [ {y}_{i} {h}_{i} ]} \\ {h}_{i} ∈ [ - 1 , 1 ] \qquad Equation 10$$

where [symbol] is the true class label of example i (+1 for click, −1 for not click) and hᵢ is the predicted score (<0 for not click) as output by the gᵤ. The targeting system assigns more weight to any example that has an error.

The targeting system trains the gating classifier g to decide which of the two classifiers to use for the final prediction. The targeting system trains the gating classifier to predict clicks on an independently drawn validation set. The output of this gating classifier is a weight w such that the final score may be defined as

\hat{p}^{(u)}=wgᵤ+(1−w)gₛ

w=g(gᵤ; gₛ) Equation 11:

where gᵤ is the output of the corrected consumer-only classifier and gₛ is the output of the social network model. This final score may be continuously updated as the behavioral targeting model or the social network model is updated.

As to the result of the ensemble classifier (i.e., the gating classifier), a 5% average improvement has been found across several ad categories. Improvement in performance is measured at the operating point of the targeting system. It has been found that, in all the categories, performance was never worse when the targeting system uses the ensemble classifier. In other words, performance of the targeting system with the ensemble classifier is always at least as good as performance of the targeting system with just the consumer-only classifier.

### Method Outline

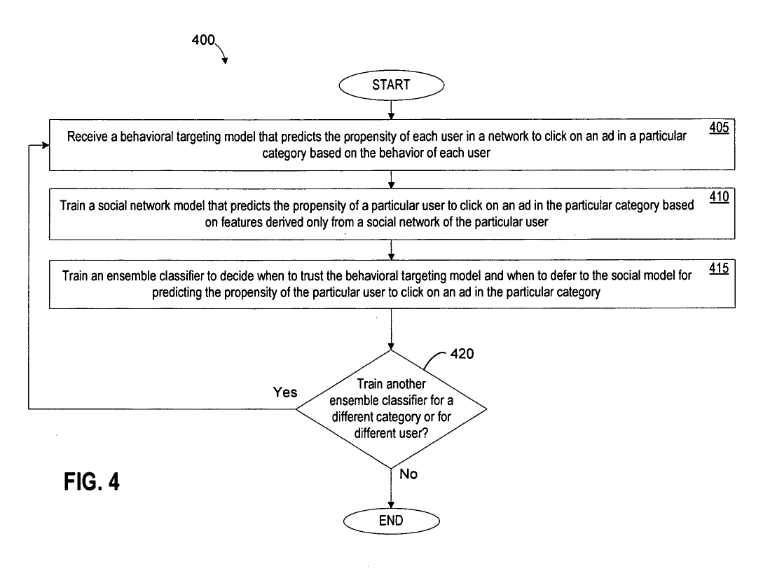

FIG. 4 is a flowchart of a method 400 for targeting ads by effectively combining behavioral targeting and social networking, in accordance with an embodiment of the present invention. The targeting system 135 of FIG. 1 may be configured to carry out the steps of the method 400. The method 400 starts in step 405 where the system receives a behavior targeting model. The method 400 may also involve training of the behavioral targeting model. The behavioral targeting model predicts the propensity of each consumer in a network to select (e.g., click on) an ad in a particular category based on the behavior of each consumer. The network includes at least one particular consumer and a social network of the particular consumer. The behavior targeting model includes a calculation of behavioral targeting predicted scores for each consumer in the network. A behavioral targeting predicted score predicts the propensity of the particular consumer to select an ad in a particular category. The behavioral targeting model includes at least a behavioral targeting predicted score of a particular consumer and a behavioral targeting predicted score of each of the particular consumer's friends (who are also users).

The method 400 then moves to step 410 where the system trains a social network model. The social network model predicts a propensity of the consumer to select an ad in the particular category based on features derived only from the social network of the particular consumer. Next, in step 415, the system trains an ensemble classifier to decide when to trust the behavioral targeting model and when to defer to the social network model for predicting a propensity of the particular consumer to select an ad of the particular category. The method 400 then moves to decision operation 420 where the system determines if an ensemble classifier is to be trained for a different category. If another ensemble classifier is to be trained, then the method 400 returns to step 405 and continues. However, if another classifier is not to be trained, then the method 400 is at an end.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human consumer or other mechanism utilizing the results of the present invention. Such software may include, but is not limited to, device drivers, operating systems, and consumer applications. Ultimately, such computer readable media further includes software for performing the present invention, as described above.

Included in the programming (software) of the general/specialized computer or microprocessor are software modules for implementing the teachings of the present invention, including without limitation receiving a behavioral targeting model to predict a propensity of each consumer in a network to select an ad of a particular category based on a behavior of each consumer, training a social network model to predict a propensity of a particular consumer to select an ad of the particular category based on features derived from a social network of the particular consumer, and training an ensemble classifier to decide when to trust the behavioral targeting model and when to defer to the social model for predicting a propensity of the particular consumer to select an ad of the particular category, according to processes of the present invention.

### Advantages

The targeting system provides an efficient algorithm to predict a consumer's propensity to click on an ad. The algorithm is a data driven approach to quantify the value of social information. The targeting system provides an approach to determine the value of “trust” among users and their friends. The targeting system is a combined, ensemble approach to combine consumer behavior information with social network information.

Advertising on social networks has recently become an important business due to the popularity of such sites as Facebook.com and MySpace.com. There are two factors for success of the advertising strategy of the targeting system of present invention. The first is whether social links are correlated with response rates for particular ads. The second is whether social links are a better predictor of responses than a consumer's behavior. The response rate on ads is proportional to the number of friends who have responded to an ad in the past. The targeting system combines information in a consumer's social neighborhood with the consumer's behavioral profile. This combination outperforms the behavioral method when there is insufficient data in the profile.

The description here is not limited to the specific embodiment described here but also includes other embodiments that are logically related. For example, extracting different ad-relevant social subgraphs appears to be a promising approach. The targeting system could use algorithms based on maximum likelihood methods to find a set of, say k, social subgraphs that best explain a consumer's trust in the consumer's neighborhood for k ad classes. Results show that a consumer's set of friends fall only within a substantially small proportion of the consumer's nearest neighbors in terms of behavior. Having users explicitly declaring shared interests and seeking out other similar users would increase the predictive ability. As advertising on social network increases in popularity, it will become important to introduce relevant advertisements instead of viral spam. The targeting system here improves ad delivery by modeling large-scale social networks.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for targeting ads by effectively combining behavioral targeting and social networking, the method comprising:
receiving a behavioral targeting model to predict a propensity of each consumer in a network to select an ad of a particular category based on a behavior of each consumer;
training a social network model to predict a propensity of a particular consumer to select an ad of the particular category based on features derived from a social network of the particular consumer; and
training an ensemble classifier to decide when to trust the behavioral targeting model and when to defer to the social model for predicting a propensity of the particular consumer to select an ad of the particular category.

2. The method of claim 1, wherein the network includes the particular consumer and the social network of the particular consumer.

3. The method of claim 1, wherein the behavioral targeting model includes at least:
a behavioral targeting predictive score of the particular consumer; and
a behavioral targeting predictive score of at least one friend of the social network.

4. The method of claim 1, wherein training the social network model comprises:
forming a behavioral profile of the consumer by collecting over a time period at least one of network browsing information, network navigation information, and network communication information;
collecting social network information, including at least one of a number of friends the particular consumer has, a strength of each relationship of each friend and the particular consumer, interests of the friends, and interests of the particular consumer; and
leveraging the social network information to predict a likelihood that the particular consumer will select an ad.

5. The method of claim 4, wherein forming the behavioral profile comprises using the behavioral targeting predictive scores from the behavioral targeting model.

6. The method of claim 1, further comprising using the ensemble classifier to:
determine that behavioral information for the particular consumer is insufficient for predicting a propensity of the particular consumer to select an ad of the particular category; and
decide to defer to the social network model to predict a propensity of the particular consumer to select an ad of the particular category.

7. The method of claim 1, further comprising using the ensemble classifier to:
determine that click information for the particular consumer for the particular category is insufficient for predicting a propensity of the particular consumer to select an ad of the particular category; and
decide to defer to the social network model to predict a propensity of the particular consumer to select an ad of the particular category.

8. The method of claim 1, wherein training the social network comprises:
determining a most trusted friend for selecting an ad of the particular category; and
determining a least trusted friend for selecting an ad of the particular category.

9. The method of claim 1, wherein training the social network model comprises analyzing a social graph representation of the social network to compute at least one of:
a number of friends in the social network of the particular consumer;
a connectivity strength between the particular consumer and at least one friend of the social network;
gender of friends of the social network;
age of friends of the social network; and
a distribution of behavioral targeting predictive scores of friends of the social network.

10. The method of claim 8, wherein determining the most trusted friend comprises assigning more trust to friends who tend to be delivered ads similar to ads delivered to the particular consumer, and wherein determining the least trusted friend comprises assigning less trust to friends who tend to be delivered ads dissimilar to ads delivered to the particular consumer.

11. A system for targeting ads by effectively combining behavioral targeting and social networking, wherein the system is configured for:
receiving a behavioral targeting model to predict a propensity of each consumer in a network to select an ad of a particular category based on a behavior of each consumer;
training a social network model to predict a propensity of a particular consumer to select an ad of the particular category based on features derived from a social network of the particular consumer; and
training an ensemble classifier to decide when to trust the behavioral targeting model and when to defer to the social model for predicting a propensity of the particular consumer to select an ad of the particular category.

12. The system of claim 11, wherein the network includes the particular consumer and the social network of the particular consumer.

13. The system of claim 11, wherein the behavioral targeting model includes at least:
a behavioral targeting predictive score of the particular consumer; and
a behavioral targeting predictive score of at least one friend of the social network.

14. The system of claim 11, wherein training the social network model comprises:
forming a behavioral profile of the consumer by collecting over a time period at least one of network browsing information, network navigation information, and network communication information;
collecting social network information, including at least one of a number of friends the particular consumer has, a strength of each relationship of each friend and the particular consumer, interests of the friends, and interests of the particular consumer; and
leveraging the social network information to predict a likelihood that the particular consumer will select an ad.

15. The system of claim 14, wherein forming the behavioral profile comprises using the behavioral targeting predictive scores from the behavioral targeting model.

16. The system of claim 11, wherein the ensemble classifier is configured to:
determine that behavioral information for the particular consumer is insufficient for predicting a propensity of the particular consumer to select an ad of the particular category; and
decide to defer to the social network model to predict a propensity of the particular consumer to select an ad of the particular category.

17. The system of claim 11, wherein the ensemble classifier is configured to:
determine that click information for the particular consumer for the particular category is insufficient for predicting a propensity of the particular consumer to select an ad of the particular category; and
decide to defer to the social network model to predict a propensity of the particular consumer to select an ad of the particular category.

18. The system of claim 11, the training the social network comprises:
determining a most trusted friend for selecting an ad of the particular category; and
determining a least trusted friend for selecting an ad of the particular category.

19. The system of claim 11, wherein training the social network model comprises analyzing a social graph representation of the social network to compute at least one of:
a number of friends in the social network of the particular consumer;
a connectivity strength between the particular consumer and at least one friend of the social network;
gender of friends of the social network;
age of friends of the social network; and
a distribution of behavioral targeting predictive scores of friends of the social network.

20. The system of claim 18, wherein determining the most trusted friend comprises assigning more trust to friends who tend to be delivered ads similar to ads delivered to the particular consumer, and wherein determining the least trusted friend comprises assigning less trust to friends who tend to be delivered ads dissimilar to ads delivered to the particular consumer.

21. A computer readable medium carrying one or more instructions for targeting ads by effectively combining behavioral targeting and social networking, wherein the one or more instructions, when executed by one or more processors, cause the one or more processors to perform the steps of:
receiving a behavioral targeting model to predict a propensity of each consumer in a network to select an ad of a particular category based on a behavior of each consumer;
training a social network model to predict a propensity of the particular consumer to select an ad of the particular category based on features derived from a social network of the particular consumer; and
training an ensemble classifier to decide when to trust the behavioral targeting model and when to defer to the social model for predicting a propensity of the particular consumer to select an ad of the particular category.
